(19) United States
(12) Patent Application Publication
(10) Pub. No.: US 2019/0128157 A1
(43) Pub. Date: May 2, 2019

(54) SELECTION OF ENGINE MAPS BASED ON IN-SITU DETECTION OF VISCOSITY

(71) Applicant: ExxonMobil Research and Engineering Company, Annandale, NJ (US)

(72) Inventors: Michael L. Alessi, Rose Valley, PA (US); Samuel C. Bainbridge, Philadelphia, PA (US); Riccardo Conti, Medford, NJ (US)

(21) Appl. No.: 16/165,145

(22) Filed: Oct. 19, 2018

Related U.S. Application Data
(60) Provisional application No. 62/580,485, filed on Nov. 2, 2017.

(51) Int. Cl. F01M 11/10; F02D 11/02; F02D 41/04

(52) U.S. Cl. CPC F01M 11/10; F02D 11/02; F02D 2200/023; F01M 2250/60; F02D 41/04

(57) ABSTRACT

Systems and methods are provided for in-situ determination of engine oil viscosity to allow for selection of an engine map by an engine control module (ECM) to match the detected viscosity. The new engine map selected based on the viscosity can correspond to an engine map based on an engine oil with a different HTHS viscosity than the prior engine map. Instead of requiring a reprogramming of an ECM when the engine oil is changed, an ECM can have access to a plurality of engine maps corresponding to different engine oils at a given HTHS viscosity and/or at different HTHS viscosities. The ability of an ECM to select an engine map corresponding to a different HTHS viscosity based on in-situ viscosity detection can allow the oil in an engine to be changed without requiring access to the ECM for reprogramming.

### CROSS-REFERENCE TO RELATED APPLICATIONS

This application claims the benefit of U.S. Provisional Application No. 62/580,485, filed on Nov. 2, 2017, the entire contents of which are incorporated herein by reference.

### FIELD

This invention relates to systems and methods for selection of engine maps based on in-situ detection of engine oil viscosity.

### BACKGROUND

High Temperature High Shear (HTHS) viscosity corresponds to a viscosity property of lubricants that can be measured under specific high shear conditions, such as the conditions described in ASTM D4683. Traditionally, selection of engine oils for diesel vehicle engines has been limited based on industry standards and/or regulations that specified a narrow acceptable range of HTHS viscosities. This narrow range corresponds to using an engine oil having a HTHS viscosity of at least 3.5 cP, or at least 3.7 cP in most diesel engines.

Higher values of HTHS viscosity have generally been preferred due to perceived benefits for extending the lifetime of engine parts exposed to high shear conditions. However, lubricants with lower HTHS viscosities can provide improve fuel economy. The potential fuel economy improvements may lead to relaxing of standards and/or regulations so that lubricants with lower viscosities can be used in various types of diesel engines.

U.S. Pat. No. 6,216,528 describes methods for determining a viscosity and/or oil grade for an engine oil in engines that have hydraulically-actuated electronically controlled unit injectors. In such engines, the oil can also serve as the actuating fluid for controlling the timing and amount of fuel delivery to the fuel injectors. The viscosity is detected based on flow rate, pressure, and temperature of the engine oil. The viscosity can then be compared with predetermined maps of oil grades to determine a viscosity range for the actuating fluid as a function of temperature.

U.S. Pat. No. 9,175,595 describes methods for detecting a viscosity of an engine oil to control the rate of coolant flow to an engine oil reservoir. The output of an engine oil sensor is compared with an expected viscosity based on the engine settings in an ECM. If the viscosity is greater than an expected value, the coolant flow valve is closed to increase the temperature of the oil. If the viscosity is less than an expected value, the coolant flow valve is opened to decrease the temperature of the oil.

### SUMMARY

In an aspect, a method for operating an engine is provided. The method includes determining a kinematic viscosity of oil in an engine. The engine can include an engine control module operating based on a first engine map. At least a portion of the first engine map can be associated with a first engine oil grade. The determined kinematic viscosity can then be matched with a kinematic viscosity from a plurality of stored kinematic viscosity values. The plurality of stored kinematic viscosity values can be associated with a plurality of engine oil grades. An engine oil grade can then be identified corresponding to the matched kinematic viscosity. For example, the identified engine oil grade can correspond to an HTHS viscosity different from an HTHS viscosity of the first engine oil grade. At least a portion of a second engine map can be selected based on association with the identified engine oil grade. The engine can then be operated based on the selected at least a portion of the second engine map. The first engine oil grade and second engine oil grade can correspond to various convenient oil grades. For example, in some aspects the first engine oil grade comprises a HTHS viscosity of 3.5 cP or more and the identified engine oil grade comprises a HTHS viscosity of 3.2 cP or less. As another example, in some aspects the first engine oil grade comprises a HTHS viscosity of 2.9 cP or more and the identified engine oil grade comprises a HTHS viscosity of 2.3 cP or less. Optionally, the difference between the identified engine oil grade and the first engine oil grade can be at least 0.3 cP.

In some aspects, an engine oil grade can be identified based on identifying an HTHS viscosity category, which can correspond to one or more engine oil grades. In such aspects, the at least a portion of the second engine can be selected based on the HTHS viscosity category.

In some aspects, the method can further include determining a temperature associated with the oil in the engine. In such aspects, matching a kinematic viscosity with the determined kinematic viscosity can correspond to matching a kinematic viscosity at the determined temperature with the determined kinematic viscosity.

A variety of options can be used for selecting a time for determining the kinematic viscosity of oil in an engine. In some aspects, the method can further include detecting removal of oil below a first threshold level in the engine followed by detecting addition of oil above a second threshold level in the engine. This can indicate, for example, an engine oil change. The determining of the kinematic viscosity of oil in the engine can optionally be responsive to the detection of removal of oil and the detection of addition of oil. Additionally or alternately, the detection of kinematic viscosity can be triggered based on a user request, such as a user request received via a user interface in the passenger cabin of the vehicle.

In another aspect, a system for operating an engine is provided. The system can include an engine that includes an oil gallery and an engine control module. The engine control module can optionally include a plurality of engine maps and a plurality of kinematic viscosity values associated with a plurality of engine oil grades and/or a plurality of HTHS viscosity categories. In such an option, the plurality of engine maps can correspond to the plurality of engine oil grades and/or the plurality of HTHS viscosity categories. The system can further include a viscosity sensor in communication with the engine control module for determining a kinematic viscosity associated with oil in the oil gallery. The system can further include a temperature sensor in communication with the engine control module, the temperature sensor configured to provide a temperature associated with the oil in the oil gallery. Optionally, the system can further include a user interface in communication with the engine control module, the user interface being accessible using a display in the passenger compartment.

### BRIEF DESCRIPTION OF THE FIGURES

FIG. 1 shows an example of a process flow for selecting at least a portion of an engine map based on a measured kinematic viscosity.

FIG. 2 shows an example of an engine configuration suitable for selecting at least a portion of an engine map based on a measured kinematic viscosity.

FIG. 3 shows gallery pressure values at different engine speeds for oils of various HTHS.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for in-situ determination of engine oil viscosity to allow for selection of an engine map by an engine control module (ECM) to match the detected viscosity. The new engine map selected based on the viscosity can correspond to an engine map based on an engine oil with a different HTHS viscosity than the prior engine map, such as an HTHS viscosity difference of 0.3 cP or more, or 0.5 cP or more, or 0.8 cP or more. Instead of requiring a reprogramming of an ECM when the engine oil is changed, an ECM can have access to a plurality of engine maps corresponding to different engine oils at a given HTHS viscosity and/or at different HTHS viscosities. The ability of an ECM to select an engine map corresponding to a different HTHS viscosity based on in-situ viscosity detection can allow the oil in an engine to be changed without requiring access to the ECM for reprogramming. This can allow vehicle owners to make engine oil changes without requiring access to specialized equipment and/or without requiring a change in one or more oil pumps in the engine.

Conventionally, many types of diesel engines have been designed for use with engine oils having a limited range of HTHS viscosity values, such as HTHS viscosity values of at least 3.5 or at least 3.7. Many grades of oil commonly used in passenger vehicles (such as 10W-40) correspond to this HTHS viscosity specification. However, changes in specifications or regulations, as well as changes in engine designs, may increasingly allow engines to use engine oils with lower HTHS viscosities.

One of the potential difficulties with having additional options when selecting an engine lubricant is the potential for selecting a lubricant that does not match the settings in the engine control module (ECM) of an engine. It is noted that an engine control module can sometimes be referred to as an engine control unit (ECU). This can cause a variety of problems within an engine environment. For example, many modern engines can include oil pressure sensors to determine if sufficient oil is present in the engine to continue operation without damaging the engine. If the detected oil pressure is too low, the engine will “de-rate” and operate in a low power mode that constrains the speed of the vehicle. However, the oil pressure within an engine is roughly correlated with the viscosity of the engine oil. If the ECM of the engine is expecting a higher viscosity oil than the oil actually present in the engine, the pressure threshold for de-rating will be too high, and the engine may de-rate while having an acceptable level of oil. Alternatively, if the ECM of the engine is expecting a lower viscosity oil than the oil actually present in the engine, the pressure threshold of de-rating will be too low. This can result in allowing the engine to continue operation at oil levels that may harm the engine (i.e., de-rating will not occur due to low oil levels).

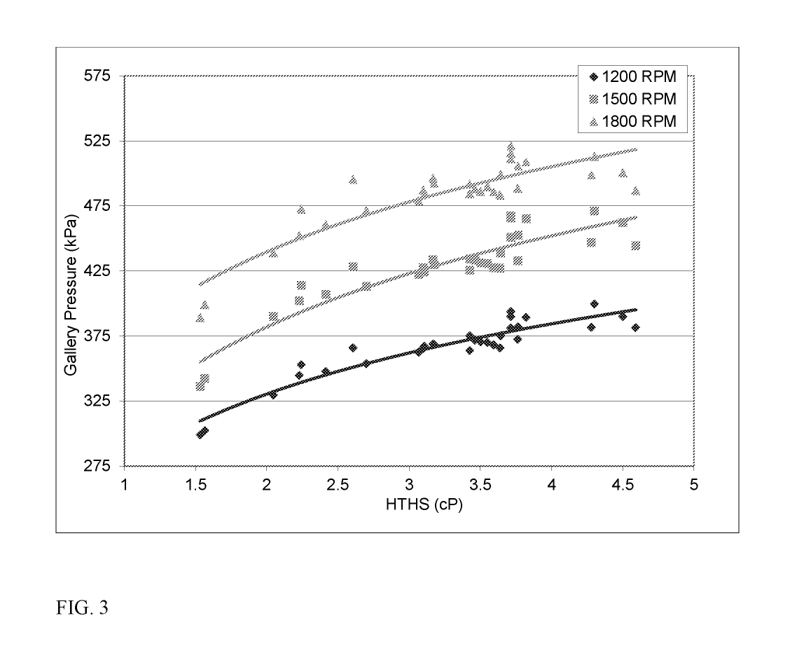

FIG. 3 shows an example of how the gallery pressure in an engine can vary depending on the HTHS viscosity of the oil used in the engine. The data in FIG. 3 corresponds to results generated during measurement of HTHS viscosity of engine oils of various engine oil grades and HTHS viscosity categories. The same type of engine configuration was used for all of the measurements in FIG. 3. During the HTHS viscosity measurements, a gallery pressure was measured. As shown in FIG. 3, at a constant engine speed, the gallery pressure increases with increasing HTHS viscosity. As an example, at an engine speed of 1500 rpm, engine oils with a HTHS viscosity of −3.5 cP all demonstrated a gallery pressure of greater than 425 kPa. By contrast, almost all of the engine oils with a HTHS viscosity of 3.0 cP or less demonstrated a gallery pressure of less than 425 kPa. More generally, a line corresponding to a curve fit for the data points at each engine speed is also provided, showing that the increase in gallery pressure with increasing HTHS viscosity is maintained independently of engine speed. The results in FIG. 3 illustrate the potential difficulties with having an oil grade in an engine that is different from the expected oil grade. If the oil grade has a HTHS viscosity that is lower than the expected HTHS viscosity in the engine map, any pressure measurements within the engine will likely indicate that the oil pressure is too low. Thus, even though the engine may have the appropriate amount of oil, the low pressures detected in the engine may cause the ECM to “de-rate” in order to avoid engine damage.

In various aspects, the above difficulties can be overcome by detecting in-situ the viscosity of the engine oil in an engine and then selecting an engine map in the ECM that matches the detected viscosity. The ECM of an engine can include a plurality of engine maps that correspond to various types of engine oils that optionally have various HTHS viscosities. When it is desired to verify the nature of the engine oil, the kinematic viscosity of the engine oil in the engine can be determined using a viscosity sensor. For example, the kinematic viscosity can be detected any time an oil change is performed. The viscosity can be determined at any convenient location, such as a location corresponding to the gallery pressure for the engine oil in the engine. Based on the engine operating parameters during kinematic viscosity detection, such as the temperature, the determined kinematic viscosity can be compared with kinematic viscosities for engine oils that have available engine maps in the ECM. The engine map corresponding to engine oil grade having the best match with the determined viscosity can be selected for use in operating the engine.

In various aspects, the HTHS viscosity of the oil previously in the engine can be different from the HTHS viscosity of the engine oil identified based on the determined viscosity. The difference in HTHS viscosity can be at least 0.3 cP, or at least 0.5 cP, or at least 0.8 cP.

In some aspects, the change in HTHS viscosity between the prior engine oil and the new engine oil can be based on a prior engine oil having an HTHS viscosity of 3.5 or more, or 3.7 or more, while the new engine oil has a HTHS viscosity of 3.2 or less, or 2.9 or less. In some aspects, the change in HTHS viscosity between the prior engine oil and the new engine oil can be based on a prior engine oil having an HTHS viscosity of 2.9 or more, while the new engine oil has a HTHS viscosity of 2.3 or less, or 2.0 or less. For example, the oil grades of 0W-40, 5W-40, and 10W-40 all have a minimum HTHS viscosity requirement of 3.5 cP, and therefore can be considered oil grades having the same or a similar HTHS viscosity. If the prior oil grade in an engine is 5W-40, and a new oil grade of 0W-30 is introduced into the engine, the new oil grade will have an HTHS viscosity minimum requirement of only 2.9 cP, which is 0.6 cP lower than the prior oil grade.

In some aspects, a different engine map can be available for each type of engine oil grade. In other aspects, a different engine map can be available for each HTHS viscosity category of engine oil. An HTHS viscosity category is defined as one or more engine oil grades that are formulated to satisfy the same HTHS viscosity requirement under a regulation or standard. For example, an engine map for an HTHS viscosity category of at least 3.5 cP could be used when an engine oil grade corresponding to 0W-40, 5W-40, or 10W-40 is identified based on a measured kinematic viscosity. In still other aspects, a combination of engine maps for HTHS viscosity categories and individual oil grades can be used.

Although the HTHS viscosity specification has been one of the traditional limits on using different types of engine oils (i.e., a specification based on industry standards and/or regulations), in various aspects the kinematic viscosity of the engine oil can be used for identification of the oil grade. The kinematic viscosity can be determined during operation of the engine and corrected for temperature. The location for measuring the viscosity can be any convenient location. Suitable locations can include an oil gallery or passageway within the engine. A temperature of the engine oil can also be obtained that is characteristic of the engine oil temperature during the kinematic viscosity measurement. The temperature does not need be sampled at the same location as the viscosity and/or in the same oil gallery, so long as the measured temperature is sufficiently similar and/or related to the temperature at the location for measuring the kinematic viscosity. It is noted that the temperature measurement can be used to correct the viscosity for different temperatures.

The measured kinematic viscosity value (optionally in conjunction with the measured temperature value) can then be compared with stored kinematic viscosity values for various oil grades. The oil grade having the closest stored kinematic viscosity value (optionally at the measurement temperature) can be identified as the matching oil grade. If the measurement temperature does not match a stored temperature for the kinematic viscosity values, the stored kinematic viscosity values can be used to calculate kinematic viscosities for the various oil grades. The engine map (or at least a portion of the engine map related to engine oil grade) can then be selected based on the matching oil grade.

### Selecting an Engine Map

Conventionally, the engine map for an engine corresponds to a plurality of settings used by the engine control module (ECM) to control the operation of the engine. The settings in the engine map can include, but are not limited to, settings specifying the timing for the combustion event in the engine based on the current engine speed and load; settings specifying the amount of fuel and air to deliver to the combustion chamber; and settings specifying the amount of oil to pump through one or more oil circulation loops in the engine. Because many of these settings are critical to allowing the engine to operate, the settings are typically stored in a type of memory that is persistent in the absence of power, and retained if the battery is temporarily disconnected. For example, the settings for the engine map can be conventionally stored in an erasable programmable read-only memory (EPROM). Such a type of memory can be rewritten, such as by exposing the memory to ultraviolet light to clear the memory and then writing a new engine map.

In various aspects, instead of having the entire engine map specification determined by information stored in a programmable read-only memory, at least a portion of the engine map can be determined in response to a detected kinematic viscosity of the engine oil. This can be handled in a variety of manners. In some aspects, a full engine map with a default engine oil grade can be stored in read-only memory, as would occur in a conventional ECM. A second portion of read-only memory can be used to store parameters based on various engine oil grades. The parameters can correspond to the portion of an engine map that is dependent on the engine oil grade. After identifying the engine oil grade, the ECM can access the corresponding parameters from the second portion of memory. These parameters can be stored in a memory local to the ECM for use, or can be accessed as needed from the second portion of memory. The ECM can access these parameters instead of using the engine oil-related parameters from the first portion of the read-only memory.

As another option, based on recent advances which have reduced the size required for a given amount of computer memory, the ECM can have associated memory that includes full engine maps for all potential engine oil grades that are recognized by the ECM. In this type of aspect, the ECM could then access that full engine map based on a detected viscosity, either by accessing as needed from storage or be loading a desired engine map into a specific memory location.

The strategy for how to store information for multiple engine maps is potentially dependent on the strategy/timing for when detection of an engine oil grade is performed. Various strategies for detecting an engine oil grade are available, and such strategies can be used independently or in conjunction with one or more other strategies. For example, detection of kinematic viscosity for determining an engine oil grade can be performed the first time the engine is started after a power loss event (e.g., after disconnecting the battery). As another example, detection of kinematic viscosity for determining an engine oil grade can be performed each time the engine is started. In still another example, detection of kinematic viscosity for determining an engine oil grade can be performed when a gallery pressure is detected that is outside of a range of expected gallery pressures for the engine at a current operating speed. In yet another example, if a sensor is available that can detect that an oil removal and fill sequence has occurred, detection of kinematic viscosity for determining an engine oil grade can be performed in response to the removal and fill sequence. Such a sequence could be detected, for example, if a sensor is available that can determine a low engine oil fill level while the engine is not running. If the engine oil fill level drops below a first threshold value and then returns to above a second threshold value, such a fill level sensor could send a signal indicating than a removal and fill sequence has occurred. As still another example, detection of kinematic viscosity for determining an engine oil grade can be performed in response to triggering of such detection by a user. Optionally, this triggering can be performed based on a mechanical trigger in the engine compartment (e.g., a button or switch), or this triggering can be performed via a user interface, such as a user interface that can be accessed from a display screen in the passenger compartment.

It is noted that detection of a kinematic viscosity in an engine does not have to correspond to detection for determining an engine oil grade. For example, it may be desirable to detect kinematic viscosity during engine operation to determine if the engine oil is deteriorating. In such an example, it may be desirable to retain an existing engine map, even though some change in expected kinematic viscosity has occurred. By avoiding the trigger of determining an engine oil grade at intermediate times, a change in engine map due to a smaller change in measured kinematic viscosity can be avoided.

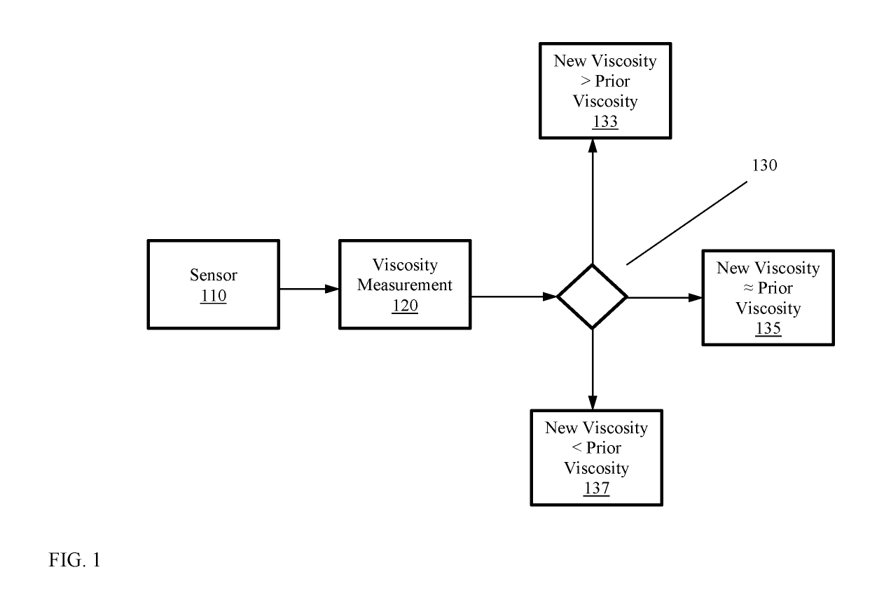

FIG. 1 shows an example of a process flow for selecting an engine map, or at least a portion of an engine map, based on measurement of kinematic viscosity of oil in an engine. In FIG. 1, a viscosity sensor 110 can be used to perform a viscosity measurement 120, such as a measurement of kinematic viscosity. The kinematic viscosity can then be compared 130 with stored values of kinematic viscosity. Optionally, the stored values can be temperature dependent. If the measured value is greater than 133 the prior viscosity by a threshold difference amount, a new engine map (or portion of an engine map) can be selected. Similarly, if the measured value is less than 137 the prior viscosity by the threshold difference, a new engine map (or portion of an engine map) can be selected. If the measured value is similar 135 to the prior viscosity, the engine map currently being used by the engine control module can be retained.

### Configuration Example

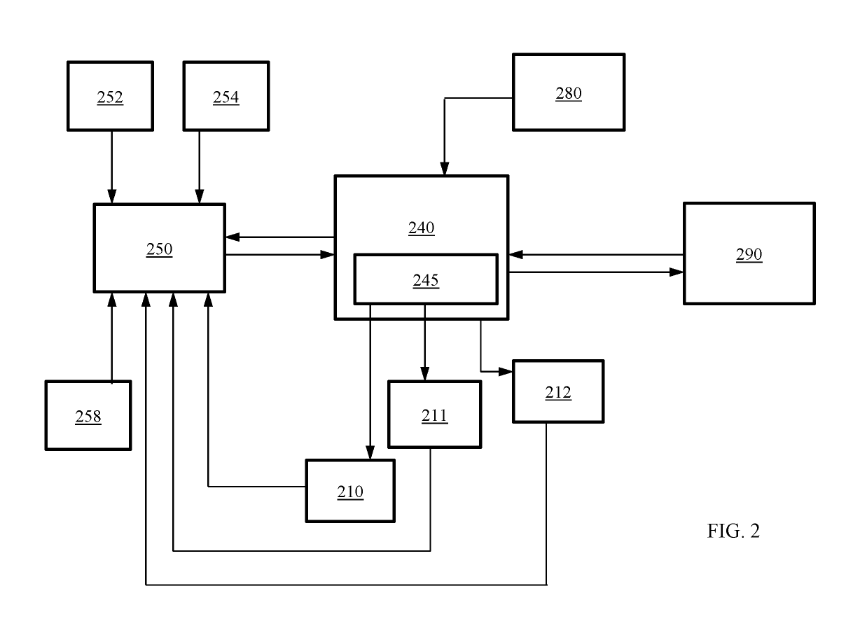

FIG. 2 schematically shows an example of an engine configuration, including an engine control module configuration, suitable for allowing selection of (at least a portion of) an engine map based on a measured or determined kinematic viscosity. In FIG. 2, an engine 240 can include at least one gallery 245 or other oil conduits and/or locations that are suitable for using a viscosity sensor 210 (or sensors) to measure kinematic viscosity and/or perform a measurement that can be used to determine a kinematic viscosity. It is noted that viscosity sensor 210 is shown outside of engine 240 for convenience, but it is understood that the various sensors, control modules, and other features in FIG. 2 can be integrated into engine 240. In addition to viscosity sensor(s) 210, one or more temperature sensor 211 and one or more pressure sensors 212 can also be used to characterize the environment in engine 240, such as characterizing a temperature and/or pressure associated with the engine oil in at least one gallery 245. The sensor outputs from viscosity sensor(s) 210, temperature sensor(s) 211, and pressure sensor(s) 212 can be passed into an engine control module (ECM) 250.

The ECM 250 can use the sensor outputs to control the operation of engine 240 in accordance with an engine map. The engine map can be stored in one or more locations, depending on the aspect. In various aspects, a plurality of engine maps can be stored in programmable read-only memory 252, such as an erasable programmable read-only memory. Optionally, some of the engine maps stored in programmable read-only memory 252 can correspond to portions of an engine map, such as portions of an engine map that are related to/dependent on the nature of the engine oil grade. Such portions of an engine map can be used in conjunction with other portions that define parameters that are not dependent on engine oil grade. Memory 254 can contain information related to kinematic viscosity values for various engine oil grades, optionally as a function of temperature, for use when determining the engine oil grade in engine 240. Optionally, memory 254 can correspond to programmable read-only memory, such as the same type of memory as programmable read-only memory 252. In some aspects, information from programmable read-only memory 252 and/or memory 254 can be transferred to an additional memory 258 to provide the full engine map used by ECM 250 in a single set of memory locations. In various aspects, programmable read-only memory 252, memory 254, and additional memory 258 can correspond to any convenient type of non-transitory memory that is suitable for use in association with an ECM 250. In some aspects, one or more of programmable read-only memory 252, memory 254, or additional memory 258 can include computer-executable instructions that, when executed, perform selection of an engine map as described herein. It is noted that programmable read-only memory 252, memory 254, and additional memory 258 are shown as separate elements, but all of these could correspond to different portions of a single memory structure.

During operation, when it is desired to determine the engine oil grade, viscosity sensor 210 and optionally temperature sensor 211 can be used to characterize the oil in gallery 245. The values can be passed to ECM 250, and compared with stored values from programmable read-only memory 254. Based on the comparison, the engine oil grade in engine 240 can be determined. If the engine oil grade is different from the oil grade for the current engine map, a new engine map and/or a new portion of an engine map can be selected in programmable read-only memory 252. Optionally, the new engine map information can be stored in memory 258 for access by the ECM 250 during operation of engine 240.

If desired, a determination of engine oil grade and selection of a new engine map can be triggered based on user input. In some aspects, user input can be provided from within the engine compartment, such as by activating a switch or button 280. In some aspects, user input can be provided within the passenger compartment, such as by using a user interface 290. Of course, if desired, a switch or button could be provided in the passenger compartment and/or a user interface could be provided in the engine compartment.

### ADDITIONAL EMBODIMENTS

### Embodiment 1

A method for operating an engine, comprising: determining a kinematic viscosity of oil in an engine, the engine comprising an engine control module using a first engine map, at least a portion of the first engine map being associated with a first engine oil grade; matching a kinematic viscosity from a plurality of stored kinematic viscosity values with the determined kinematic viscosity, the plurality of stored kinematic viscosity values being associated with a plurality of engine oil grades; identifying an engine oil grade corresponding to the matched kinematic viscosity, the identified engine oil grade comprising an HTHS viscosity different from an HTHS viscosity of the first engine oil grade; selecting at least a portion of a second engine map associated with the identified engine oil grade; and operating the engine based on the selected at least a portion of the second engine map.

### Embodiment 2

The method of Embodiment 1, wherein identifying an engine oil grade comprises identifying an HTHS viscosity category corresponding to one or more engine oil grades, the selecting at least a portion of a second engine map associated with the identified engine oil grade optionally comprising selecting the at least a portion of the second engine map based on the identified HTHS viscosity category.

### Embodiment 3

The method of any of the above embodiments, wherein selecting at least a portion of a second engine map associated with the identified engine oil grade comprises selecting the at least a portion of the second engine map based on an HTHS viscosity category corresponding to the identified engine oil grade.

### Embodiment 4

The method of any of the above embodiments, wherein the first engine oil grade comprises a HTHS viscosity of 3.5 cP or more and the identified engine oil grade comprises a HTHS viscosity of 3.2 cP or less (or 3.0 cP or less); or wherein the first engine oil grade comprises a HTHS viscosity of 2.9 cP or more and the identified engine oil grade comprises a HTHS viscosity of 2.3 cP or less (or 2.0 cP or less).

### Embodiment 5

The method of any of the above embodiments, wherein a difference between the identified engine oil grade and the first engine oil grade is at least 0.3 cP (or at least 0.5 cP, or at least 0.8 cP).

### Embodiment 6

The method of any of the above embodiments, wherein operating the engine based on the selected at least a portion of the second engine map comprises operating the engine based on the second engine map.

### Embodiment 7

The method of any of the above embodiments, wherein determining a kinematic viscosity of oil in an engine further comprises determining a temperature associated with the oil in the engine, and wherein matching a kinematic viscosity with the determined kinematic viscosity comprises matching a kinematic viscosity at the determined temperature with the determined kinematic viscosity.

### Embodiment 8

The method of any of the above embodiments, the method further comprising: detecting removal of oil below a first threshold level in the engine; and detecting addition of oil above a second threshold level in the engine, wherein the determining a kinematic viscosity of oil in the engine is responsive to the detection of removal of oil and the detection of addition of oil.

### Embodiment 9

The method of any of Embodiments 1 to 7, wherein the determining a kinematic viscosity of oil in the engine is responsive to a triggering event by a user, the triggering event optionally comprising receiving user input from a user interface, the user interface being provided in a passenger compartment of a vehicle associated with the engine.

### Embodiment 10

An engine system, comprising an engine control module and non-transitory memory associated with the engine control module, the non-transitory memory including computer-executable instructions that, when executed, provide a method for operating an engine according to any of Embodiments 1-9.

### Embodiment 11

A system for operating an engine, comprising: an engine comprising an oil gallery; an engine control module comprising a plurality of engine maps and a plurality of kinematic viscosity values associated with a plurality of engine oil grades, the plurality of engine maps corresponding to the plurality of engine oil grades; a viscosity sensor in communication with the engine control module for determining a kinematic viscosity associated with oil in the oil gallery; and a temperature sensor in communication with the engine control module, the temperature sensor configured to provide a temperature associated with the oil in the oil gallery.

### Embodiment 12

The system of Embodiment 11, wherein the engine control module further comprises a selected engine map for operating the engine, the selected engine map corresponding to a first engine oil grade, the oil gallery comprising oil having a second engine oil grade.

### Embodiment 13

The system of Embodiment 11 or 12, wherein the plurality of kinematic viscosity values are associated with the plurality of engine oil grades based on associated with a plurality of HTHS viscosity categories, and wherein the plurality of engine maps correspond to the plurality of engine oil grades based on corresponding to a plurality of HTHS viscosity categories.

### Embodiment 14

The system of any of Embodiments 11 to 13, wherein the plurality of engine maps comprise a plurality of portions of engine maps, the plurality of portions of engine maps comprising parameters associated with an engine oil grade.

### Embodiment 15

The system of any of Embodiments 11 to 14, further comprising a user interface in communication with the engine control module, the user interface being accessible using a display in the passenger compartment.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for operating an engine, comprising:
determining a kinematic viscosity of oil in an engine, the engine comprising an engine control module using a first engine map, at least a portion of the first engine map being associated with a first engine oil grade;
matching a kinematic viscosity from a plurality of stored kinematic viscosity values with the determined kinematic viscosity, the plurality of stored kinematic viscosity values being associated with a plurality of engine oil grades;
identifying an engine oil grade corresponding to the matched kinematic viscosity, the identified engine oil grade comprising an HTHS viscosity different from an HTHS viscosity of the first engine oil grade;
selecting at least a portion of a second engine map associated with the identified engine oil grade; and
operating the engine based on the selected at least a portion of the second engine map.

2. The method of claim 1, wherein identifying an engine oil grade comprises identifying an HTHS viscosity category corresponding to one or more engine oil grades.

3. The method of claim 2, wherein selecting at least a portion of a second engine map associated with the identified engine oil grade comprises selecting the at least a portion of the second engine map based on the identified HTHS viscosity category.

4. The method of claim 1, wherein selecting at least a portion of a second engine map associated with the identified engine oil grade comprises selecting the at least a portion of the second engine map based on an HTHS viscosity category corresponding to the identified engine oil grade.

5. The method of claim 1, wherein the first engine oil grade comprises a HTHS viscosity of 3.5 cP or more and the identified engine oil grade comprises a HTHS viscosity of 3.2 cP or less.

6. The method of claim 1, wherein the first engine oil grade comprises a HTHS viscosity of 2.9 cP or more and the identified engine oil grade comprises a HTHS viscosity of 2.3 cP or less.

7. The method of claim 1, wherein a difference between the identified engine oil grade and the first engine oil grade is at least 0.3 cP.

8. The method of claim 1, wherein operating the engine based on the selected at least a portion of the second engine map comprises operating the engine based on the second engine map.

9. The method of claim 1, wherein determining a kinematic viscosity of oil in an engine further comprises determining a temperature associated with the oil in the engine, and wherein matching a kinematic viscosity with the determined kinematic viscosity comprises matching a kinematic viscosity at the determined temperature with the determined kinematic viscosity.

10. The method of claim 1, the method further comprising:
detecting removal of oil below a first threshold level in the engine; and
detecting addition of oil above a second threshold level in the engine,
wherein the determining a kinematic viscosity of oil in the engine is responsive to the detection of removal of oil and the detection of addition of oil.

11. The method of claim 1, wherein the determining a kinematic viscosity of oil in the engine is responsive to a triggering event by a user.

12. The method of claim 11, wherein the triggering event comprises receiving user input from a user interface, the user interface being provided in a passenger compartment of a vehicle associated with the engine.

13. An engine system, comprising an engine control module and non-transitory memory associated with the engine control module, the non-transitory memory including computer-executable instructions that, when executed, provide a method for operating an engine comprising:
determining a kinematic viscosity of oil in an engine, the engine comprising an engine control module using a first engine map, at least a portion of the first engine map being associated with a first engine oil grade;
matching a kinematic viscosity from a plurality of stored kinematic viscosity values with the determined kinematic viscosity, the plurality of stored kinematic viscosity values being associated with a plurality of engine oil grades;
identifying an engine oil grade corresponding to the matched kinematic viscosity, the identified engine oil grade comprising an HTHS viscosity different from an HTHS viscosity of the first engine oil grade;
selecting at least a portion of a second engine map associated with the identified engine oil grade; and
operating the engine based on the selected at least a portion of the second engine map.

14. A system for operating an engine, comprising:
an engine comprising an oil gallery;
an engine control module comprising a plurality of engine maps and a plurality of kinematic viscosity values associated with a plurality of engine oil grades, the plurality of engine maps corresponding to the plurality of engine oil grades;
a viscosity sensor in communication with the engine control module for measuring a kinematic viscosity associated with oil in the oil gallery; and
a temperature sensor in communication with the engine control module for measuring a temperature associated with oil in the oil gallery.

15. The system of claim 14, wherein the engine control module further comprises a selected engine map for operating the engine, the selected engine map corresponding to a first engine oil grade, the oil gallery comprising oil having a second engine oil grade.

16. The system of claim 15, wherein the first engine oil grade comprises a HTHS viscosity of 3.5 cP or more and the second engine oil grade comprises a HTHS viscosity of 3.2 cP or less.

17. The system of claim 15, wherein the first engine oil grade comprises a HTHS viscosity of 2.9 cP or more and the second engine oil grade comprises a HTHS viscosity of 2.3 cP or less.

18. The system of claim 14, wherein the plurality of kinematic viscosity values are associated with the plurality of engine oil grades based on associated with a plurality of HTHS viscosity categories, and wherein the plurality of engine maps correspond to the plurality of engine oil grades based on corresponding to a plurality of HTHS viscosity categories.

19. The system of claim 14, wherein the plurality of engine maps comprise a plurality of portions of engine maps, the plurality of portions of engine maps comprising parameters associated with an engine oil grade.

20. The system of claim 14, further comprising a user interface in communication with the engine control module, the user interface being accessible using a display in the passenger compartment.
